(19) United States
(12) Patent Application Publication
(10) Pub. No.: US 2017/0234787 A1
(43) Pub. Date: Aug. 17, 2017

(54) POROUS MEDIUM EXTRACTION SYSTEM, POROUS MEDIUM SENSOR ASSEMBLY AND POROUS MEDIUM INFILTROMETER

(71) Applicant: EDAPHIS INC., Lévis (CA)

(72) Inventor: Jean CARON, Lévis (CA)

(21) Appl. No.: 15/433,710

(22) Filed: Feb. 15, 2017

Related U.S. Application Data
(60) Provisional application No. 62/295,357, filed on Feb. 15, 2016.

(51) Int. Cl. G01N 15/08; G01N 1/08

(52) U.S. Cl. CPC G01N 15/0826; G01N 15/0806; G01N 1/08

(57) ABSTRACT

A porous medium extraction system has an access tube, an impact head and a porous medium extracting screw. The access tube has an access tube wall defining an open-ended channel extending along a longitudinal axis. A lower end of the access tube wall includes a cutting edge bevelled towards an inner surface of the access tube wall. The impact head is engageable with an upper end of the access tube wall. The porous medium extracting screw is insertable in the open-ended channel of the access tube and is engageable with the porous medium located inside the open-ended channel upon insertion of the access tube in the porous medium. The porous medium extracting screw is rotatable to extract the porous medium from the open-ended channel. A porous medium infiltrometer and a porous medium sensor assembly include the access tube of the porous medium extraction system.

### CROSS-REFERENCE TO RELATED APPLICATIONS

This application claims priority under 35USC§119(e) of U.S. provisional patent application 62/295,357 filed on Feb. 15, 2016, the specification of which is hereby incorporated by reference.

### TECHNICAL FIELD OF THE INVENTION

The present invention relates to the field of apparatuses and/or systems for measurement of porous medium conditions. More particularly, it relates to a porous medium extraction system for insertion of an access tube in the porous medium and to a porous medium sensor assembly and/or a porous medium infiltrometer for measuring properties of the porous medium.

### BACKGROUND

In the field of apparatuses and/or systems for measuring porous medium conditions, it is desirable that the apparatuses and/or systems create limited disturbance of the porous medium when a component thereof is inserted in the porous medium. Indeed, limited disturbance is highly advantageous to ensure that the measures obtained are as accurate as possible.

However, known apparatuses and/or systems for porous medium extraction and/or insertion of a component in the porous medium (which can subsequently be used as part of a measuring system of the porous medium conditions) tend to cause disturbance of the porous medium. In other words, they tend to cause compaction of the porous medium in the vicinity of the inserted component, which disturbs (i.e. modifies) the porous medium and has an effect on the conditions thereof. Such disturbance is undesirable as it can negatively impact the quality of the measures obtained.

In view of the above, there is a need for an improved porous medium extraction system, porous medium sensor assembly and/or porous medium infiltrometer which, by virtue of its design and components, would be able to overcome or at least minimize some of the above-discussed prior art concerns.

### SUMMARY OF THE INVENTION

According to a first general aspect, there is provided a porous medium infiltrometer insertable in a porous medium. The porous medium infiltrometer comprises an access tube and a water supply and sensor assembly. The access tube is at least partially insertable in the porous medium and has an access tube wall defining a channel therein and a porous medium access port extending through the access tube. The porous medium access port is located in the porous medium upon insertion of the porous medium infiltrometer therein. The water supply and sensor assembly is at least partially insertable in the channel of the access tube and comprises a water permeable member, a watertight tube, a water injection and withdrawal unit, and a pressure sensor. The water permeable member is insertable in the porous medium access port of the access tube. The watertight tube is insertable in the channel of the access tube and is in liquid communication with the water permeable member. The water injection and withdrawal unit is in liquid communication with the watertight tube and is operative to sequentially inject water in the watertight tube and withdraw water therefrom. The pressure sensor is operatively connected to the watertight tube and is operative to measure water pressure in the watertight tube.

According to another general aspect, there is also provided a porous medium extraction system. The porous medium extraction system comprises an access tube, an impact head and a porous medium extracting screw. The access tube has an access tube wall with an outer surface, an inner surface, an upper end, and an opposed lower end. The access tube wall defines an open-ended channel extending along a longitudinal axis of the access tube. The lower end of the access tube wall comprises a cutting edge bevelled towards the inner surface of the access tube wall. The impact head is engageable with the upper end of the access tube wall. The porous medium extracting screw is insertable in the open-ended channel of the access tube and is engageable with the porous medium located inside the open-ended channel upon insertion of the access tube in the porous medium. The porous medium extracting screw is rotatable to extract the porous medium from the open-ended channel.

According to another general aspect, there is provided a porous medium sensor assembly insertable in a porous medium. The porous medium sensor assembly comprises an access tube, an insertion assembly and at least one of a water permeable member and a porous medium sensor mounted to the insertion assembly. The access tube is at least partially insertable in the porous medium and has an access tube wall defining a channel therein and a porous medium access port extending through the access tube wall. The porous medium access port is located in the porous medium upon insertion of the porous medium measure assembly therein. The insertion assembly is configurable in a compacted configuration and an expanded configuration. The at least one of the water permeable member and the porous medium sensor is mounted to the insertion assembly and is longitudinally movable inside the access tube in the compacted configuration of the insertion assembly and at least partially inserted in the porous medium access port of the access tube in the expanded configuration of the insertion assembly.

According to another general aspect, there is provided a porous medium infiltrometer insertable in a porous medium. The porous medium infiltrometer comprises: an access tube at least partially insertable in the porous medium, the access tube having an access tube wall defining a channel therein and a sensing member cavity defined in an outer surface of the access tube wall, the sensing member cavity being located in the porous medium upon insertion of the porous medium infiltrometer therein; and a water supply and sensor assembly engageable with the access tube. The water supply and sensor assembly comprises: a water permeable member insertable in the sensing member cavity of the access tube; a watertight tube in liquid communication with the water permeable member; a water injection and withdrawal unit in liquid communication with the watertight tube and operative to sequentially inject water in the watertight tube and withdraw water therefrom; and a pressure sensor operatively connected to the watertight tube and operative to measure water pressure in the watertight tube.

In an embodiment, the watertight tube comprises a gas collection section spaced-apart along the watertight tube from the pressure sensor and the water supply and sensor assembly further comprises a gas extraction assembly operatively connected to the watertight tube. The gas extraction assembly comprises: a gas evacuation port in fluid communication with the gas collection section of the watertight tube, the gas evacuation port being configurable between an open configuration allowing gas evacuation from the gas collection section of the watertight tube and a closed configuration preventing gas evacuation from the gas collection section of the watertight tube; and a sealing member positioned downstream of the gas collection section of the watertight tube and configurable in a sealed configuration sealing the watertight tube and an unsealed configuration allowing fluid transfer in the watertight tube, the sealing member being configured in the sealed configuration when the gas evacuation port is configured in the open configuration. The watertight tube can comprise a main section and a pressure sensor section, the gas collection section and the pressure sensor section branching from the main section and being located upstream thereof, the pressure sensor being located above the gas collection section when the access tube is at least partially inserted in the porous medium.

In an embodiment, the sensing member cavity is a porous medium access port extending through the access tube wall and at least a section of the watertight tube of the water supply and sensor assembly is at least partially insertable in the channel of the access tube to be in liquid communication with the water permeable member from a rear surface thereof. The water supply and sensor assembly can further comprise an insertion assembly, the water permeable member being mounted to the insertion assembly, the insertion assembly being configurable in a compacted configuration for insertion and translation of the water permeable member in the channel of the access tube and an expanded configuration wherein the water permeable member is at least partially inserted in the porous medium access port. The water permeable member can comprise a front surface contacting the porous medium when the porous medium infiltrometer is at least partially inserted therein and the insertion assembly can be configured in the expanded configuration with the front surface projecting outside of the access tube, beyond the outer surface of the access tube wall.

In an embodiment, the water permeable member is secured to the access tube with a section of the access tube wall extending rearwardly of the water permeable member and preventing liquid and gas communication between the channel of the access tube and the water permeable member through the sensing member cavity. The access tube can further comprise a connector channel defined in an outer surface of the access tube wall and extending longitudinally therealong from an upper end thereof and intersecting with the sensing member cavity and wherein the watertight tube can be at least partially inserted in the connector channel and operatively connected to the water permeable member to be in liquid communication therewith.

In an embodiment, the access tube comprises a plurality of longitudinally spaced-apart sensing member cavities defined in the access tube wall and a plurality of water supply and sensor assemblies and wherein the water permeable member of each one of the plurality of water supply and sensor assemblies being contained in a corresponding one of the plurality of sensing member cavities. A distance between consecutive ones of the sensing member cavities can be between about 5 centimeters and about 100 centimeters.

In an embodiment, the access tube comprises a porous medium outlet defined through the access tube wall, above the sensing member cavity. A lower end of the access tube can comprise a cutting edge bevelled towards an inner surface of the access tube wall.

In an embodiment, the water supply and sensor assembly further comprises an access tube coupling engageable with an upper end of the access tube to couple the water supply and sensor assembly with the access tube.

According to another general aspect, there is provided a porous medium extraction system comprising: an access tube having an access tube wall with an outer surface, an inner surface, an upper end, and an opposed lower end, and defining an open-ended channel extending along a longitudinal axis of the access tube, the lower end of the access tube comprising a cutting edge bevelled towards the inner surface of the access tube wall; an impact head engageable with the upper end of the access tube; and a porous medium extracting screw insertable in the open-ended channel of the access tube and being engageable with the porous medium located inside the open-ended channel upon insertion of the access tube in the porous medium, the porous medium extracting screw being rotatable to extract the porous medium from the open-ended channel.

In an embodiment, the cutting edge comprises a plurality of teeth.

In an embodiment, the impact head is mounted to the porous medium extracting screw and is movable about the longitudinal axis between a distal configuration and an engaged configuration and impacting on the upper end of the access tube wall when brought in the engaged configuration to drive the access tube into the porous medium.

The porous medium extraction system of any one of claims 8 to 10, wherein the access tube comprises at least one porous medium outlet extending through the access tube wall in an upper section thereof, the at least one porous medium outlet being sized and shaped to allow the porous medium conveyed upwardly by the porous medium extracting screw to exit through the open-ended channel. The access tube can include a lower access tube section detachably engageable with an upper access tube section, the lower access tube section being at least partially insertable in the porous medium and the upper access tube section extending at least partially outside of the porous medium upon insertion of the access tube therein. The upper access tube section can comprise at least one of the at least one porous medium outlet and the lower access tube section can comprise at least one sensing member cavity defined in an outer surface of the access tube wall, the at least one sensing member cavity being located in the porous medium upon insertion of the access tube therein. The lower access tube section of the access tube can further comprise a rotation lock extending from the outer surface of the access tube wall, the rotation lock being engageable to substantially prevent the rotation of the lower access tube section of the access tube during insertion of the access tube in the porous medium.

In an embodiment, the access tube comprises an expansion assembly channel defined in an outer surface of the access tube wall and the porous medium extraction system further comprises an expansion member mounted to the access tube in the expansion assembly channel, the expansion member being selectively configurable in an insertion configuration wherein the expansion member is contained in the expansion assembly channel and an expanded configuration wherein the expansion member protrudes outwardly from the expansion assembly channel. The access tube can comprise at least one sensing member cavity defined in an outer surface of the access tube, in a lower section thereof. The at least one sensing member cavity can comprise at least two longitudinally spaced-apart sensing member cavities. The expansion assembly channel can comprise a longitudinal section, the longitudinal section being diametrically opposed to the at least one sensing member cavity. The expansion assembly channel can further comprise a transversal section intersecting with the longitudinal section and extending at least along half of a periphery of the access tube. The access tube can comprise at least one porous medium outlet extending through the access tube wall above the transversal section of the expansion assembly channel and the at least one sensing member cavity can be defined below the transversal section of the expansion assembly channel.

According to still another general aspect, there is provided a porous medium sensor assembly insertable in a porous medium. The porous medium sensor assembly comprises: an access tube at least partially insertable in the porous medium, the access tube having an access tube wall defining a channel therein and a porous medium access port defined through the access tube wall, the porous medium access port being located in the porous medium upon insertion of the porous medium sensor assembly therein; an insertion assembly configurable in a compacted configuration and an expanded configuration; and at least one of a fluid permeable member and a porous medium sensor mounted to the insertion assembly, the at least one of the fluid permeable member and the porous medium sensor being longitudinally displaceable inside the access tube in the compacted configuration of the insertion assembly and being at least partially inserted in the porous medium access port of the access tube in the expanded configuration of the insertion assembly.

In an embodiment, the porous medium sensor assembly further comprises an infiltrometer assembly including: a water permeable member mounted to the insertion assembly and at least partially inserted in the porous medium access port of the access tube in the expanded configuration of the insertion assembly; a watertight tube insertable in the channel of the access tube and being in liquid communication with the water permeable member; a water injection and withdrawal unit in liquid communication with the watertight tube and operative to sequentially inject water in the watertight tube and withdraw water therefrom; and a pressure sensor operatively connected to the watertight tube and operative to measure water pressure in the watertight tube.

In an embodiment, the watertight tube comprises a gas collection section spaced-apart along the watertight tube from the pressure sensor and the infiltrometer assembly further comprises a gas extraction assembly operatively connected to the watertight tube. The gas extraction assembly comprises: a gas evacuation port in fluid communication with the gas collection section of the watertight tube, the gas evacuation port being configurable between an open configuration allowing gas evacuation from the gas collection section of the watertight tube and a closed configuration preventing gas evacuation from the gas collection section of the watertight tube; and a sealing member positioned downstream of the gas collection section of the watertight tube and configurable in a sealed configuration sealing the watertight tube and an unsealed configuration allowing fluid transfer in the watertight tube, the sealing member being configured in the sealed configuration when the gas evacuation port is configured in the open configuration.

In an embodiment, the insertion assembly comprises two semicircular sections and an expansion member located therebetween, the expansion member being operative to move the two semicircular sections away from one another to configure the insertion assembly in the expanded configuration. The two semicircular sections can be pivotally connected to one another along a longitudinal edge thereof.

In an embodiment, the at least one of the fluid permeable member and the porous medium sensor comprises a front surface contacting the porous medium in the expanded configuration of the insertion assembly inserted in the channel of the access tube.

In an embodiment, the access tube further comprises a porous medium outlet defined through the access tube wall and located above the porous medium access port.

According to a further general aspect, there is provided a porous medium sensing assembly insertable in a porous medium. The porous sensing assembly comprising: an access tube at least partially insertable in the porous medium, the access tube having an access tube wall with a sensing member cavity and an expansion assembly channel defined in an outer surface of the access tube wall, the sensing member cavity being in the porous medium upon insertion of the porous medium sensing assembly therein; at least one of a fluid permeable member and a porous medium sensor mounted to the access tube and at least partially contained in the sensing member cavity and having a front surface contacting the porous medium upon insertion of the access tube therein; and an expansion member mounted to the access tube in the expansion assembly channel, the expansion member being selectively configurable in an insertion configuration wherein the expansion member is contained in the expansion assembly channel and an expanded configuration wherein the expansion member protrudes outwardly from the expansion assembly channel.

In an embodiment, the access tube wall defines a channel and the sensing member cavity is a porous medium access port extending through the access tube wall and communicating with the channel defined by the access wall.

In an embodiment, the access tube further comprises a connector channel defined in an outer surface of the access tube wall and extending longitudinally therealong from an upper end thereof and intersecting with the sensing member cavity.

In an embodiment, the expansion assembly channel comprises a longitudinal section and a transversal section, the longitudinal section being diametrically opposed to the at least one sensing member cavity and the transversal section intersecting with the longitudinal section and extending at least along half of a periphery of the access tube.

In an embodiment, the access tube comprises at least one porous medium outlet extending through the access tube wall above the transversal section of the expansion assembly channel and the at least one sensing member cavity is defined below the transversal section of the expansion assembly channel.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a side elevation view of a porous medium extraction system in accordance with an embodiment.

FIGS. 2a and 2b are side elevation views of an upper access tube section, an impact head and a porous medium extracting screw of the porous medium extraction system of FIG. 1, wherein FIG. 2a shows the impact head in an engaged configuration and FIG. 2b shows the impact head in a distal configuration.

FIG. 3a is a side elevation view of a lower access tube section of the porous medium extraction system of FIG. 1.

FIG. 3b is a perspective view, enlarged, of a lower end of the lower access tube section of FIG. 3a.

FIG. 4 is a side elevation view of the porous medium extraction system of FIG. 1, wherein a portion of the upper access tube section extends over a section of the lower access tube section.

FIG. 5 is a side elevation view of a porous medium extraction system in accordance with an alternative embodiment wherein a portion of the lower access tube section extends over a section of the upper access tube section.

FIG. 6 is a perspective view of an infiltrometer in accordance with an embodiment, wherein a water supply and sensor assembly is coupled with the lower access tube section of the porous medium extraction system shown in FIG. 1.

FIG. 7 is a perspective view of a water supply and sensor assembly of the infiltrometer.

FIGS. 8a to 8c are top perspective views of a porous medium sensor assembly in accordance with an embodiment, wherein FIG. 8a shows an insertion assembly configured in a compacted configuration and being inserted in a channel of an access tube of the porous medium sensor assembly, FIG. 8b shows the insertion assembly configured in the compacted configuration and being positioned with fluid permeable members aligned with corresponding sensing member cavities of the access tube and FIG. 8c shows the insertion assembly configured in the expanded configuration.

FIGS. 9a and 9b are top perspective views of the insertion assembly of the porous medium sensor assembly of FIGS. 8a to 8c, wherein FIG. 9a shows the insertion assembly configured in the compacted configuration and FIG. 9b shows the insertion assembly configured in the expanded configuration.

FIG. 10a is a front elevation view, FIG. 10b is a side elevation view, and FIG. 10c is a rear elevation view of the porous medium extraction system in accordance with another embodiment, wherein the extraction system includes a single access tube section.

FIG. 11 is a top plan view of the porous medium extraction system shown in FIGS. 10a, 10b, and 10c.

FIG. 12 is a perspective view of the porous medium extraction system shown in FIGS. 10a, 10b, and 10c.

FIG. 13a is a side elevation view and FIG. 13b is a front elevation view of the porous medium extraction system shown in FIGS. 10a, 10b, and 10c, without the impact head.

FIG. 14 is a cross-sectional view along section lines 13b-13b of FIG. 13b of the porous medium extraction system.

FIG. 15 is a cross-sectional view along section lines 13a-13a of FIG. 13a of the porous medium extraction system.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the porous medium extraction system, porous medium sensor assembly and/or porous medium infiltrometer and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the porous medium extraction system, porous medium sensor assembly and/or porous medium infiltrometer, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and correspond to the position and orientation of the porous medium extraction system and corresponding parts when inserted in the porous medium, with the “upper” corresponding to a portion closer to the exposed surface of the porous medium and the “lower” corresponding to a portion opposed to the upper portion. Positional descriptions should not be considered limiting.

In the course of the present description, the term “porous medium” is used as a general term to refer to any growing medium used in horticulture or in agriculture, such as, without being limitative earthen soil, greenhouse soil and any other natural or artificial accumulation of mineral and organic component of altered and non-altered particles of different sizes.

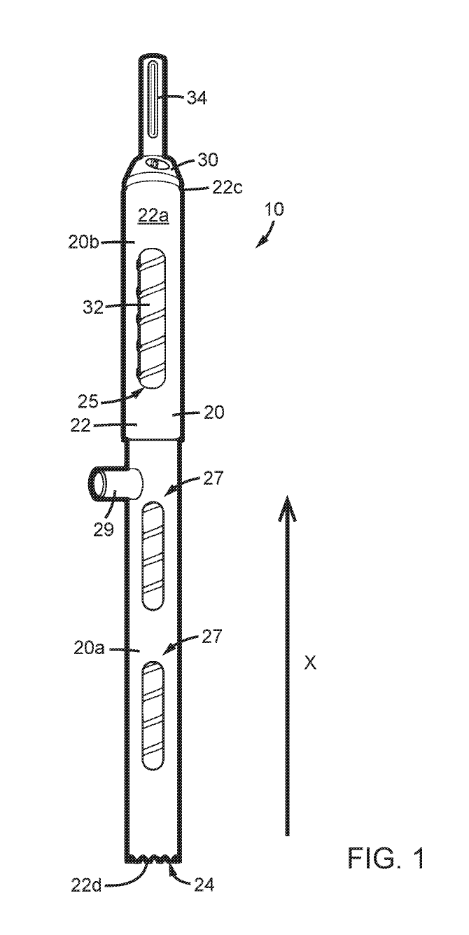

Referring generally to FIGS. 1 to 3b, there is provided a porous medium extraction system 10 in accordance with an embodiment. The porous medium extraction system 10 includes an access tube 20 insertable in the porous medium (not shown), an impact head 30 engageable with the access tube 20 and a porous medium extracting screw 32 connected to the impact head 30. The access tube 20, impact head 30 and porous medium extracting screw 32 cooperate to allow the access tube 20 to be inserted in the porous medium without substantially disturbing the porous medium outwardly adjacent to the access tube 20. In other words, the access tube 20, impact head 30 and porous medium extracting screw 32 cooperate to allow the access tube 20 to be inserted in the porous medium, without substantially compacting the porous medium surrounding the inserted access tube, such that the characteristics of the porous medium outside of the inserted access tube and in a vicinity thereof remain substantially unchanged.

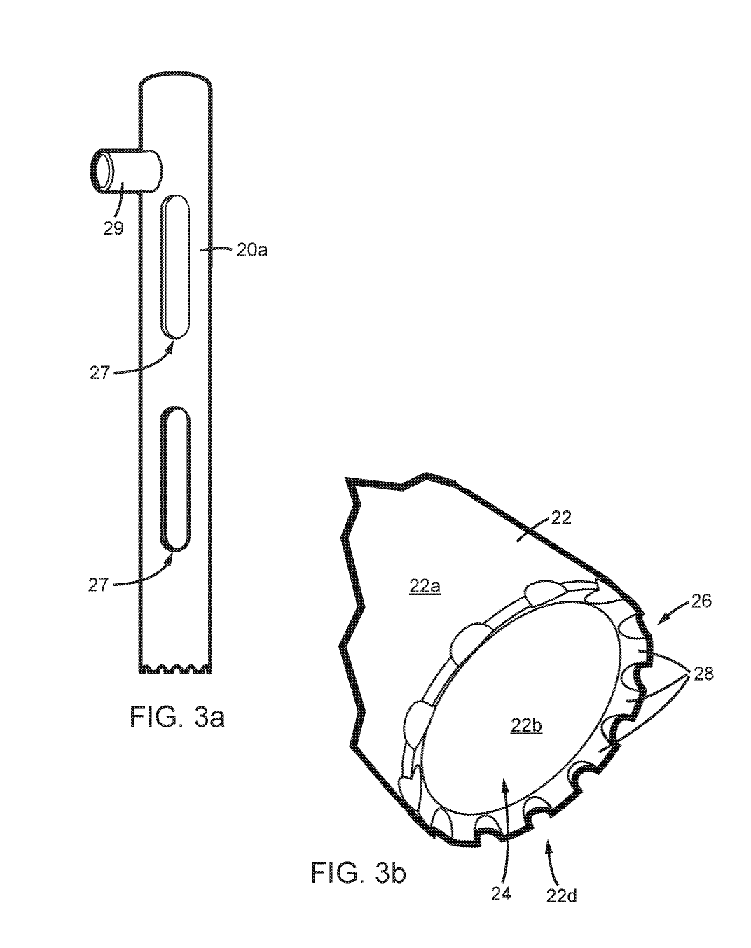

In the embodiment shown, the access tube 20 includes an access tube wall 22 defining an open-ended channel 24 which extends along a longitudinal axis X. The access tube wall 22 has an outer surface 22a, an inner surface 22b, an upper end 22c and an opposed lower end 22d. The lower end 22d of the access tube wall 22 comprises a cutting edge 26 bevelled towards the inner surface 22b of the access tube wall 22 (see FIG. 3b). Hence, when the access tube 20 is inserted in the porous medium, the cutting edge 26 causes the porous medium located inside the open-ended channel 24 to be compacted against the bevel of the inner surface 22b, while the porous medium located outside of the open-ended channel 24, in the vicinity of the access tube 20, remains substantially undisturbed.

In addition, the access tube 20 comprises at least one sensing member cavity 27 defined in the access tube wall 22. In the embodiment shown, the at least one sensing member cavity 27 is a porous medium access port extending through the access tube wall 22 and allows access to the porous medium from the inside of the open-ended channel 24. In the embodiment shown, two longitudinally spaced-apart porous medium access ports 27 are provided, defined in the access tube wall 22 above the lower end 22d. One skilled in the art will however understand that, in an alternative embodiment (not shown), more than two longitudinally spaced-apart porous medium access ports 27 can be provided. In an embodiment, the distance between consecutive ones of the porous medium access ports is between about 5 centimeters and about 100 centimeters. In another alternative embodiment (not shown), only one longitudinally porous medium access port 27 can be provided. In the embodiment shown, the two longitudinally spaced-apart porous medium access ports 27 have an oblong shape. However, it will be readily understood by one skilled in the art that the size and shape of the porous medium access ports 27 can differ from the size and shape of the porous medium access ports 27 shown in the illustrated embodiments. Furthermore, in an embodiment (not shown), the access ports can be radially spaced-apart.

The porous medium extracting screw 32 is insertable and rotatable in the open-ended channel 24 of the access tube 20 in order to extract the porous medium located inside the open-ended channel 24 when the access tube 20 is inserted in the porous medium. Indeed, the porous medium extracting screw 32 engages the porous medium located inside the open-ended channel 24 when the access tube 20 is inserted in the porous medium and rotation of the porous medium extracting screw 32 drives the porous medium upwardly in the open-ended channel 24 to perform extraction thereof, as will be described in further details hereinafter.

In the embodiment shown, the access tube 20 also comprises a porous medium outlet 25 defined in an upper portion of the access tube wall 22. In the embodiment shown, the porous medium outlet 25 extends longitudinally along the access tube wall 22 and allows the porous medium conveyed upwardly by the porous medium extracting screw 32 to be discharged from the open-ended channel 24, outwardly of the access tube 20. One skilled in the art will understand that, in alternative embodiments, more than one porous medium outlet 25 could be defined in the access tube wall 22 and/or that the porous medium outlet 25 can be positioned and/or configured differently than in the embodiment shown.

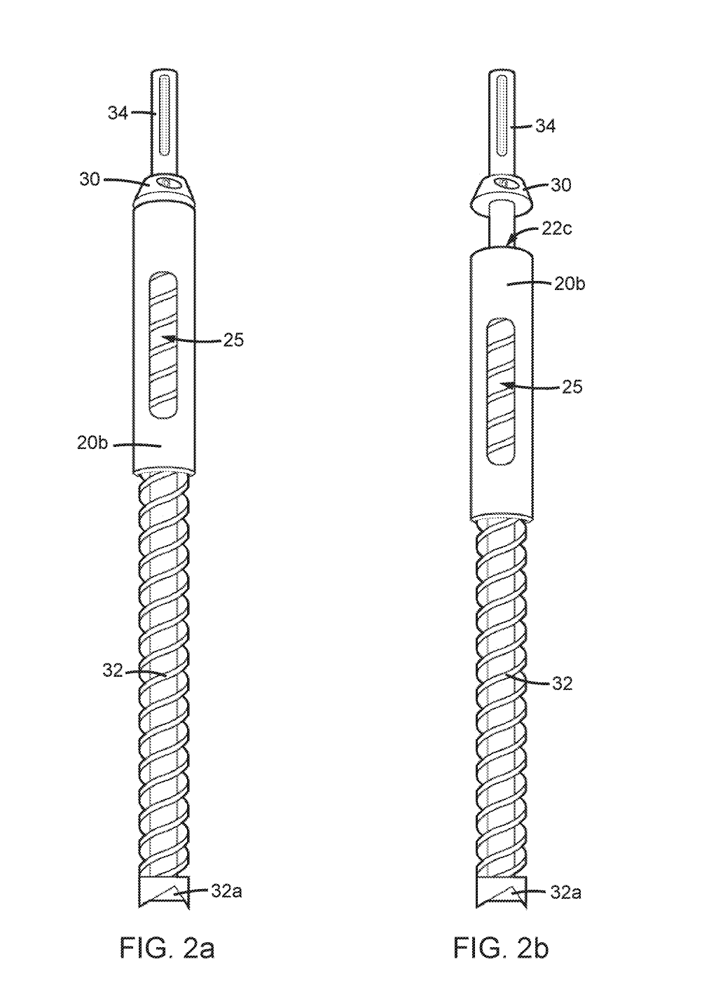

In the embodiment shown, the impact head 30 has a frustroconical outer surface and includes a contact surface at a distal end thereof. The contact surface of the impact head 30 is sized to contact the upper end 22c of the access tube wall 22 while the frustroconical outer surface is configured to receive and transfer repetitive impacts thereon to facilitate the insertion of the access tube 20 in the porous medium. As mentioned above, the impact head 30 is mounted to an upper end of the porous medium extracting screw 32, such that movement (i.e. translation and/or rotation) of the impact head 30 can result in a corresponding movement of the porous medium extracting screw 32. The impact head 30 and the porous medium extracting screw 32 are translatable along the longitudinal axis X, between a distal configuration (See FIG. 2b) where the impact head 30 is spaced apart from the upper end 22c of the access tube wall 22, and an engaged configuration (see FIG. 2a) where the impact head 30 is engaged to the upper end 22c of the access tube wall 22, i.e. the impact head 30 abuts the upper end 22c of the access tube wall 22. When the impact head 30 is translated from the distal configuration to the engaged configuration, a force is received and transferred on the upper end 22c of the access tube wall 22 to drive the access tube 20 into the porous medium.

In the embodiment shown, the impact head 30 is mounted to a shank 34, the shank 34 extending upwardly from the impact head 30 and being engageable with the chuck of a hammer drill (not shown) or other suitable percussion tool. In an embodiment, the shank 34 and the impact head 30 mounted thereto can be rotated simultaneously by the hammer drill simultaneously to being repeatedly translated between the distal configuration and the engaged configuration by the effect of the hammering action of the hammer drill. One skilled in the art will understand that, in such an embodiment, in the distal configuration, the impact head 30 may not be driven away from the upper end 22c of the access tube wall 22 as far as shown in

FIG. 2b, but rather is subjected to short, rapid translations as a result of the hammering action of the hammer drill.

In the embodiment shown, the cutting edge 26 of the access tube wall 22 comprises a plurality of teeth 28. The teeth 28 facilitate the insertion of the access tube 20 in the porous medium by allowing the cutting edge 26 to cut into the porous medium more easily as the access tube 20 is being inserted therein. One skilled in the art will understand that, in alternative embodiments, other configurations where the cutting edge 26 is bevelled towards the inner surface 22b of the access tube wall 22 could also be provided. Furthermore, the shape and the configuration of the teeth 28 can vary from the embodiment shown.

In an embodiment, the access tube 20 is configured to substantially prevent rotation thereof as it is being inserted in the porous medium to minimize the smoothing of the porous medium. For instance and as shown in FIGS. 1 and 3a, the access tube 20 can include a rotation lock 29 extending outwardly and perpendicularly from the outer surface 22a of the access tube wall 22. When seized, the rotation lock 29 has a length sufficient to create a resistance against the porous medium into which the access tube is inserted such that a rotation of the access tube 20 can be substantially prevented.

It is appreciated that, in other embodiments (not shown), the rotation lock 29 can be replaced by other mechanisms or features substantially preventing rotation of the access tube during insertion in the porous medium. For instance, a blade or stopper protruding outwardly from the outer surface of the access tube, from a lower portion thereof, and inserted simultaneously in the porous medium can prevent rotation of the access tube by increasing the friction (or rotation resistance) during insertion of the access tube. In another embodiment, the rotation lock 29 can be embodied by a handle removably engageable with the access tube and seizable to prevent rotation during insertion of the access tube in the porous medium.

In the embodiment shown, the porous medium extracting screw 32 includes a drilling end 32a. In an embodiment, the drilling end 32a of the porous medium extracting screw 32 can extend past the lower end 22d of the open-ended channel 24 of the access tube wall 22 when the access tube 20 is being inserted in the access tube 20 in the engaged configuration. The drilling end 32a has a shape facilitating the insertion of the extracting screw 32 and, simultaneously, the access tube 20 in the porous medium upon the drilling action of the porous medium extracting screw 32 therein. As shown in the illustrated embodiment, the shape of the drilling end 32a can be substantially cylindrical with sharp lower edges. In other embodiments, the shape of the porous medium extracting screw 32, including the thread design, and/or the drilling end 32a thereof can differ from the shape shown in FIG. 2 to achieve the desired porous medium extraction.

In the embodiment shown, the access tube 20 includes a lower access tube section 20a and an upper access tube section 20b detachably engageable with one another. For example and without being limitative, the lower access tube section 20a and the upper access tube section 20b can be engaged with each other by press fitting, screwing or any other connection type which allow detachable connection therebetween. When the access tube 20 is being inserted in the porous medium, the lower access tube section 20a is at least partially insertable therein, while the upper access tube section 20b remains at least partially outside of the porous medium. Such configuration allows the lower access tube section 20a and upper access tube section 20b to be connected to one another to perform insertion of the access tube 20 in the porous medium and to be subsequently disconnected from one another to leave only the lower access tube section 20a inserted in the porous medium once the insertion has been performed, such that the lower access tube section 20a is used as access tube for an infiltrometer or other suitable sensors which will be discussed in more details below.

The porous medium access port(s) 27 is (are) defined in the lower access tube section 20a such as to be located inside the porous medium, when the access tube 20 is inserted in the porous medium. The porous medium outlet 25 is defined in the upper access tube section 20b to be located above the porous medium when the access tube 20 is at least partially inserted therein. In the embodiment shown, the rotation lock 29 also extends outwardly from the outer surface 22a of the access tube wall 22 of the lower access tube section 20a to substantially prevent the rotation of the lower access tube section 20a as it is inserted in the porous medium.

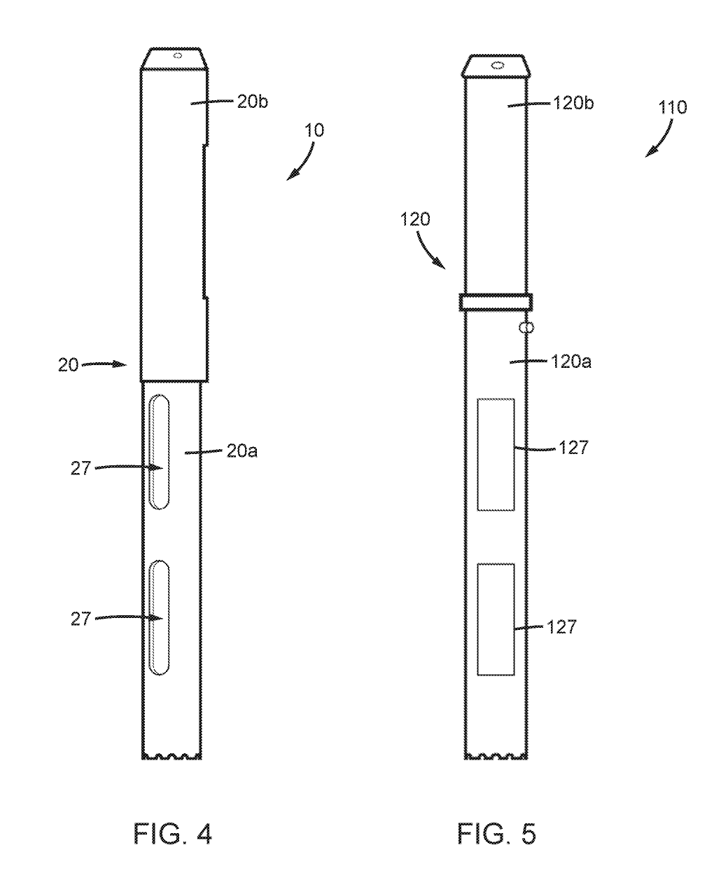

Referring to FIGS. 1 to 4, in the embodiment shown in these Figures, the lower access tube section 20a has an outside diameter smaller than an inside diameter of the upper access tube section 20b, i.e. the diameter of the elongated channel defined therein, such that a portion of the upper access tube section 20b extends over the lower access tube section 20a when the lower access tube section 20a and upper access tube section 20b are engaged to one another. In such an embodiment, the portion of the upper access tube section 20b extending over the lower access tube section 20a should remain outside of the porous medium as the access tube 20 is inserted in the porous medium, in order to ensure that the porous medium outside of the inserted access tube 20, and in the vicinity thereof, is substantially undisturbed.

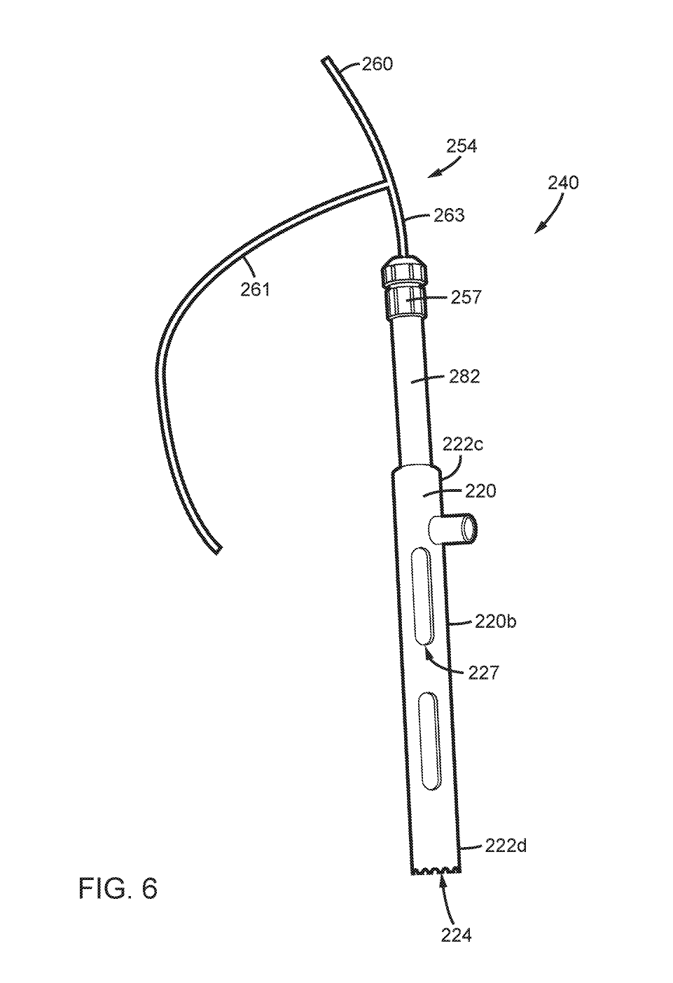

Referring to FIG. 5, there is shown an alternative embodiment of the porous medium extraction system 110 wherein similar features are numbered using the same reference numerals in the 100 series. In this alternative embodiment, the lower access tube section 120a has an inside diameter, i.e. the diameter of the elongated channel defined therein, greater than an outside diameter of the upper access tube section 120b, such that a portion of the upper access tube section 120b extends inside the lower access tube section 120a when the lower access tube section 120a and upper access tube section 120b are engaged together. In such an embodiment, the portion of the upper access tube section 120b extending inside the lower access tube section 120a can extend along the entire length of the lower access tube section 120a without risking that the porous medium outside of the inserted access tube 120, and in the vicinity thereof, is disturbed when the upper access tube section 120b is disengaged from the lower access tube section 120a subsequently to the insertion of the access tube 120 in the porous medium.

In the embodiment shown in FIG. 5, the upper access tube section 120b can also close the porous medium access ports 127 during insertion of the access tube 120 in the porous medium to ensure that no porous medium penetrates through the porous medium access ports 127 during the insertion process.

For ease of description, only the reference number in the 10 series will be used in the remaining of the description to refer to the corresponding elements. However, it is appreciated that the features described below can also be applied to the embodiment shown in FIG. 5.

As mentioned above, in an embodiment, the above described porous medium extraction system 10 can be used to insert the access tube 20 in the porous medium without substantially impacting on the porous medium, with at least one section of the access tube 20 subsequently being used as a component of an infiltrometer or any other suitable sensor. An embodiment of an infiltrometer, which can be used in combination with the access tube 20, for measuring a rate of water infiltration in the porous medium will now be described in more details below.

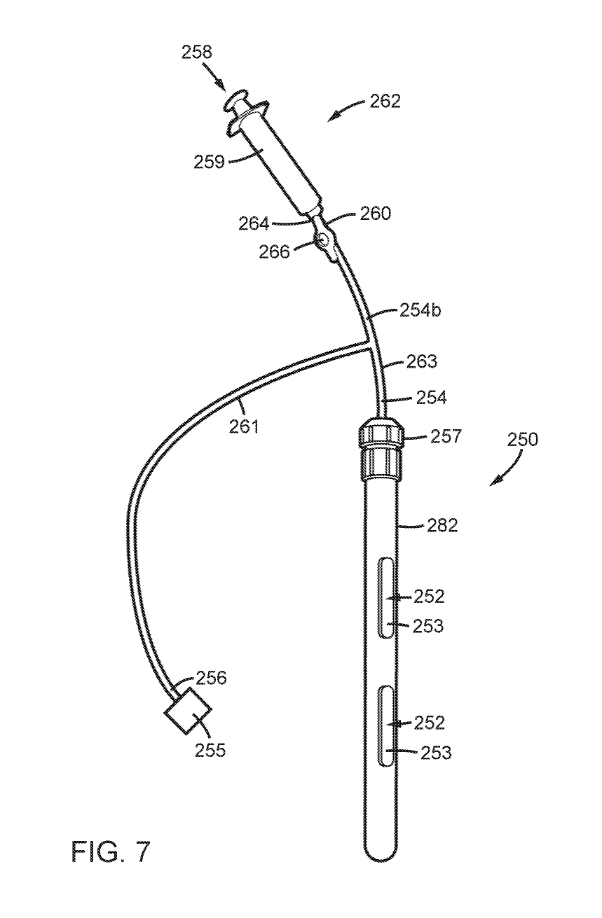

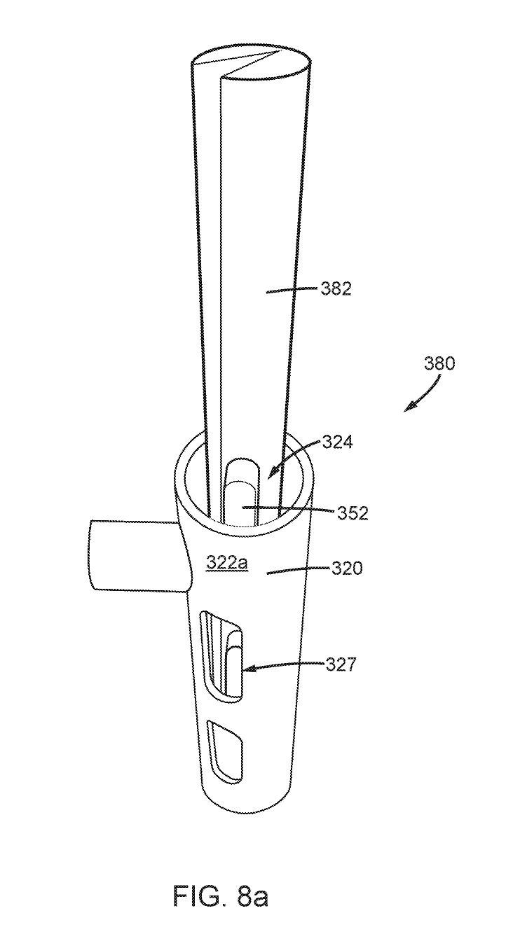

Now referring to FIGS. 6 and 7, there is provided an infiltrometer 240 insertable in the porous medium (not shown) to measure the rate of water infiltration into the porous medium. In FIGS. 6 and 7, similar features to the porous medium extraction system 10 are numbered using the same reference numerals in the 200 series. The infiltrometer 240 includes an access tube 220 as described above and a water supply and sensor assembly 250 having an insertion assembly 282, including an insertion tube, engageable with the access tube 220 and at least partially insertable in its channel. In an embodiment, at least a portion of the access tube 220 is part of the infiltrometer 240, once inserted in the porous medium.

In the embodiment shown in FIG. 6, the access tube 220 of the infiltrometer 240 corresponds to the lower access tube section 20a of the access tube 20 of the porous medium extraction system 10 described above in connection with FIGS. 1 to 5 with an opened lower end 222d. More particularly, the opened lower end 222d of the access tube 220 shown in FIG. 6 substantially corresponds to the lower end 22d shown in FIGS. 3a and 3b. FIG. 7 shows the water supply and sensor assembly 250 of the infiltrometer 240 with the insertion assembly 282 insertable in the access tube 220. In the non-limitative embodiment shown, the insertion assembly 282 of the water supply and sensor assembly 250 includes a watertight tube which is closed at the lower end 222d thereof since it is filled with water. One skilled in the art will understand that, in alternative embodiments (not shown), the infiltrometer 240 can however include an access tube 220 and a water supply and sensor assembly 250 having different configurations. For instance, in another alternative embodiment, at least one of the porous medium access port can be located at the lower end of the access tube wall rather than along the access tube wall, between the lower end and an opposed upper end.

As better shown in FIG. 7, the water supply and sensor assembly 250 includes the insertion assembly 282 insertable in the channel of the access tube 220. In an embodiment, the insertion assembly 282 includes a watertight tube having a substantially rigid body, insertable in the channel of the access tube 220. The watertight tube of the insertion assembly 282 is in fluid communication with a flexible tubing 254b, which is also part of the watertight tube, extending upwardly from the rigid watertight tube of the insertion assembly 282, the flexible tubing 254b and the rigid section of the watertight tube being in fluid communication with one another. More particularly, water flows freely inbetween, i.e. the water path is continuous. One skilled in the art will however understand that, in an embodiment (not shown), the watertight tube 254 can include only flexible or rigid sections.

The water supply and sensor assembly 250 includes an access tube coupling 257 engageable and securable to the upper end of the access tube 220 to engage and secure the water supply and sensor assembly 250 with the access tube 220. In the embodiment shown, the access tube coupling 257 is located between the flexible tubing 254b and the rigid section of the watertight tube. It is appreciated that the shape and the configuration of the access tube coupling can vary from the embodiment shown in FIGS. 6 and 7.

The watertight tube of the insertion assembly 282 is connected to a fluid permeable member 252 and, more particularly, a water permeable member insertable in the porous medium access port 227 of the access tube 220, such that the watertight tube of the insertion assembly 282 and water permeable member 252 are in liquid communication. In an embodiment, the watertight tube of the insertion assembly 282 includes water transfer apertures defined therein and allowing fluid exchange between the water permeable member 252 and the cavity defined in the tube of the insertion assembly 282, which is typically filled with water. In an alternative embodiment, the insertion assembly 282 includes water chambers defined behind each one of the water permeable members 252 and allowing liquid communication inbetween. In this embodiment, fluid exchange between the porous medium and the water chambers can only occur through the water permeable members 252.

When inserted in the porous medium access port 227, the water permeable member 252 is the component which is in contact with the porous medium and allows water to permeate through its structure to regulate the water pressure inside the watertight tube of the insertion assembly 282 based on the water tension in the porous medium. For example and without being limitative, in an embodiment, the water permeable member 252 is made of fine porous ceramic. For instance, the water permeable member 252 includes a water permeable ceramic with a low point of air entry, of sufficient hydraulic conductivity. In another embodiment, other materials, having known water conductivity properties, or the like, such as porous stainless steel, nylon, and porous plastics, can be used.

More particularly, in the embodiment wherein the access tube 220 includes at least one porous medium access port 227, the water permeable member 252 has a front surface 253, exposed to and in contact with the porous medium when the access tube 220 is at least partially inserted therein, and an opposed rear surface (not shown), exposed in or accessible from the channel of the access tube 220. Thus, the watertight tube of the insertion assembly 282 is connected to the water permeable member 252 through the rear surface and is in liquid communication therewith. As shown in FIG. 7, the watertight tube of the insertion assembly 282 is inserted into the channel of the access tube 220 through the upper open end of the access tube 220. Thus, water and gas can flow from the porous medium into the watertight tube, and vice-versa, through the water permeable member 252.

It is also appreciated that other connectors, such as electric wires or optic fiber, can extend through the channel of the access tube 220 and be optionally connected to the water permeable member 252.

In the embodiment shown, the flexible portion of the watertight tube 254 extending outwardly from the access tube 220 can be divided into a main section 263 extending outwardly from the upper end 222c of the access tube, and a gas collection section 260 and a pressure sensor section 261 branching from the main section 263. The gas collection section 260 and the pressure sensor section 261 are located upstream from the main section 263. In the present description, the term “downstream” is intended to mean closer to the access tube 220 while the term “upstream” is intended to mean further away from the access tube 220.

The watertight tube 254 is also operatively connected, at a sensor connection end 256, which can be an end of the pressure sensor section 261, to a pressure sensor 255. The pressure sensor 255 is operative to measure water pressure in the watertight tube 254, such as to evaluate the rate of water infiltration into the porous medium. Several types, models and/or brand of such pressure sensors are known to those skilled in the art. In an embodiment, the pressure sensor 255 is located above the gas collection section 260 when the access tube 222 is at least partially inserted in the porous medium in a manner such that gas contained in the watertight tube 254 is directed towards the gas collection section 260.

In the embodiment shown, the watertight tube 254 is also connected to a water injection and withdrawal unit 258, which can be an end of the gas collection section 260. However, in an alternative embodiment, it is appreciated that the water injection and withdrawal unit 258 can be mounted anywhere along the watertight tube 254. The water injection and withdrawal unit 258 is in liquid communication with the watertight tube 254 and is operative to sequentially inject water in the watertight tube 254 and withdraw water therefrom. In the embodiment shown, the water injection and withdrawal unit 258 includes a syringe 259 in liquid communication with the watertight tube 254. One skilled in the art will understand that, in alternative embodiments (not shown) other components or assemblies which allow injection and/or withdrawal of water in the watertight tube 254 while maintaining the water tightness of the watertight tube 254 can also be used. In an embodiment (not shown), the water injection and withdrawal unit 258 can be automated, i.e. it can perform water injection and withdrawal automatically.

For example and without being limitative, in an embodiment, the water injection and withdrawal unit 258 is configured to perform water injection in and/or withdrawal from the watertight tube 254, with the pressure sensor 255 measuring the evolution of the pressure in the watertight tube 254 over time, following the water injection and/or withdrawal perform by the water injection and withdrawal unit 258.

As mentioned above, in an embodiment, the infiltrometer 240 also includes the gas collection section 260 which allows the collection of gas, such as air infiltrating into the watertight tube 254 of the water supply and sensor assembly 250 over time, through the porous medium and the water permeable member 252. In an embodiment, the gas collection section 260 is a section of the watertight tube 254 that is located away from the pressure sensor 255, such that the air infiltrating into the watertight tube 254 moves towards a section of the watertight tube 254 where it does not interfere with the pressure sensor and the measures thereof. In an embodiment, the gas collection section 260 is located above the pressure sensor when the infiltrometer 240 is inserted in the porous medium.

In such an embodiment, the water supply and sensor assembly 250 further comprises a gas extraction assembly 262 operatively connected to the watertight tube 254 and which allows gas ejection from the gas collection section and, in some implementations, allows water to be reinjected into the gas collection section 260 to replace the accumulated gas such as air, without substantially impacting on the pressure in the watertight tube 254. The gas extraction assembly 262 includes a gas evacuation port 264 in fluid communication with the gas collection section 260 of the watertight tube 254 and configurable between an open configuration which allows the air to be evacuated in from the gas collection section 260 of the watertight tube 254 and a closed configuration which prevents air evacuation from the gas collection section 260 of the watertight tube 254. The gas extraction assembly 262 also includes a sealing member 266 positioned downstream of the gas collection section 260 of the watertight tube 254, closer to the main section 263 and the branching with the pressure sensor section 261. The sealing member 266 is configurable in a sealed (or closed) configuration in which it seals the watertight tube 254 shut and an unsealed (or open) configuration in which it allows fluid transfer with a section of the watertight tube 254 located upstream the sealing member 266.

In the embodiment shown, the gas extraction assembly 262 is embodied by the same syringe 259, which is used for the water injection and withdrawal unit 258. The syringe 259 is located upstream of the gas collection section 260 and is configured in the closed configuration when the syringe 259 is engaged with the watertight tube 254 and the piston is inserted into the barrel of the syringe 259 (as shown in FIG. 7) and in the open configuration when the syringe 259 is disengaged from the watertight tube 254 or when the piston is removed from the barrel of the syringe 259. In the embodiment shown, the sealing member 266 is embodied by a valve mounted to the watertight tube 254 which can be configured between the sealed configuration and the unsealed configuration.

In order to proceed with reinjection of water into the gas collection section 260 to replace the accumulated air without substantially impacting the pressure in the watertight tube 254, in the embodiment shown, the valve is initially configured from the unsealed configuration to the sealed configuration. Subsequently, the gas extraction assembly 262 is configured in the open configuration and water is injected into the gas collection section 260 of the watertight tube 254. Once water has been added, the gas extraction assembly 262 is configured in the closed configuration and the valve is configured from the sealed configuration to the unsealed configuration.

One skilled in the art will understand that, in alternative embodiments, a gas extraction assembly 262 different from the embodiment shown can also be provided to allow gas removal from the gas collection section 260 and water to be reinjected into the gas collection section 260 in replacement of the accumulated air without substantially impacting the pressure in the watertight tube 254. Furthermore, in an alternative embodiment, the gas extraction assembly 262 and the water injection withdrawal unit 258 can be distinct components. For example and without being limitative, the gas extraction assembly 262 can include a combination of valves and, optionally, one or more pump(s), such as and without being limitative peristaltic pump(s) connected to a water source for sequentially sealing/unsealing the gas collection section 260 and allowing water from the water source to be reintroduced in the gas collection section 260. In an embodiment, the gas extraction assembly 262 can be automated, i.e. it can perform water injection in the gas collection section 260 without substantially impacting the pressure in the watertight tube 254 automatically, i.e. without manual intervention.

In the embodiment shown, the infiltrometer 240 includes one water supply and sensor assembly 250. One skilled in the art will understand that, in an alternative embodiment (not shown), the infiltrometer 240 can include more than one water supply and sensor assembly 250. Moreover, in another alternative embodiment, additional sensors can be provided in additional porous medium access ports 227 located along the access tube 220. For example and without being limitative, the additional sensors can be soil tension sensors, salinity sensors, temperature sensors, oxygen sensors, water content sensors, or the like.

In an alternative embodiment, at least some of the fluid permeable members 252 can be gas permeable members. In such embodiment, gas exchange can occur between the porous medium and suitable sensors through the gas permeable members. For instance, a gas permeable member can be used to measure the gas permeability of the porous medium.

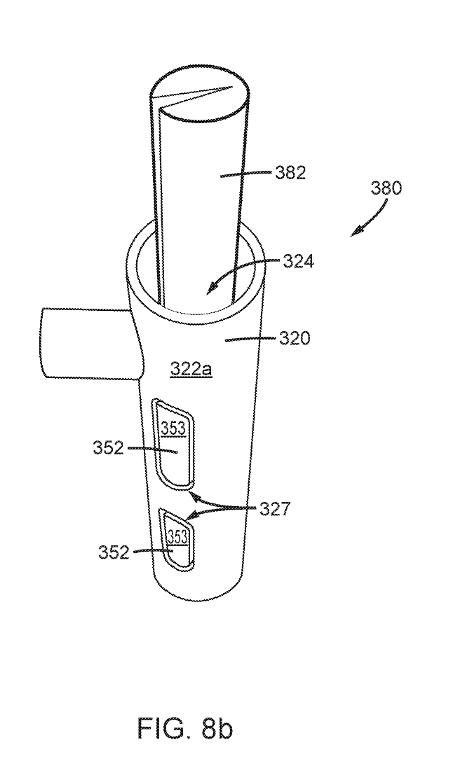

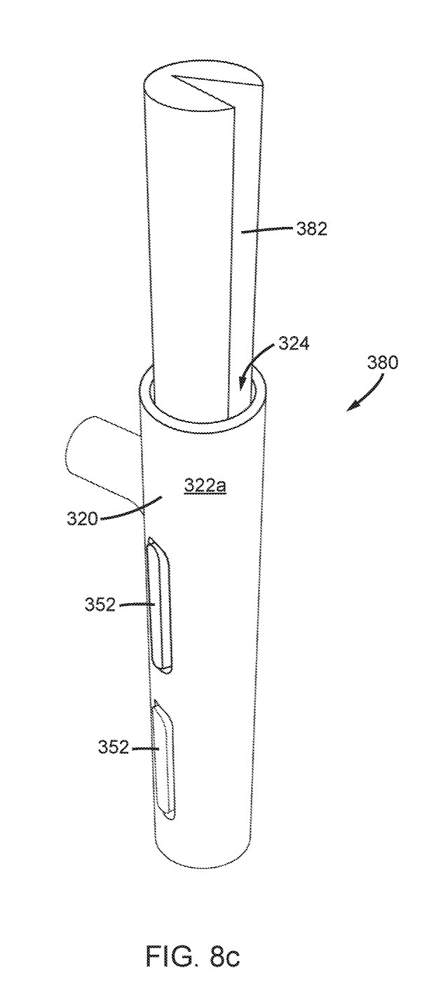

Now referring to FIGS. 8a to 9b, there is provided a porous medium sensor assembly 380 insertable in the porous medium (not shown) in order to allow measure of parameters of the substantially undisturbed porous medium, wherein similar features to the porous medium extraction system 10 and the infiltrometer 240 are numbered using the same reference numerals in the 300 series. The porous medium sensor assembly 380 includes the access tube 320 as described above and an insertion assembly 382 with at least one of a fluid permeable member 352 (such as a gas permeable member or a water permeable member) and a porous medium sensor (not shown) mounted thereto. The insertion assembly 382 allows the at least one of water permeable member 352 and the porous medium sensor to be inserted inside the channel 324 of the access tube 320 and be subsequently positioned and maintained in the corresponding one of the porous medium access port 327. For ease of description, in the description below, reference will only be made to the water permeable member 352 which can be mounted to the insertion assembly 382, but one skilled in the art will understand that similar teachings apply to porous medium sensors which can be mounted thereto. Once again, for example and without being limitative, the porous medium sensors can be soil tension sensors, salinity sensors, temperature sensors, oxygen sensors, water content sensors, or the like.

In an embodiment, the insertion assembly 382 is configurable in a compacted configuration (see FIGS. 8a, 8b and 9a) and an expanded configuration (See FIGS. 8c and 9b). When the insertion assembly 382 is configured in the compacted configuration, the insertion assembly 382 along with the water permeable member 352 mounted thereto can be translated inside the access tube 320. To the opposite, when the insertion assembly 382 is configured in the expanded configuration, the water permeable member 352 is at least partially inserted and maintained in place in the porous medium access port 327 of the access tube 320. In the expanded configuration, the overall diameter of the insertion assembly 382 is greater than the inside diameter of the access tube 320 and translation inside the channel is prevented.

Therefore, to engage the insertion assembly 382 with the access tube 220 inserted in the porous medium, the insertion assembly 382 is initially configured in the compacted configuration in order to insert the water permeable member 352 in the access tube 320 until the water permeable member 352 is substantially aligned with the corresponding porous medium access port(s) 327 (See FIGS. 8a and 8b). Once the desired position is reached, the insertion assembly 382 is configured in the expanded configuration to engage the water permeable member 352 in the corresponding porous medium access port(s) 327, such that the water permeable member 352 can engage the porous medium. In an embodiment, when the insertion assembly 382 is configured in the expanded configuration, the water permeable member 352 projects slightly outside of the access tube 320 through the medium access port 327 and a front surface 353 of the water permeable member 352 is in contact with the porous medium surrounding the access tube 220. One skilled in the art will understand that the water permeable member 352 projects sufficiently outside of the access tube 320 to provide good contact with the undisturbed porous medium and therefore provide representative measurement thereof, while not projecting enough outside of the access tube 320 to substantially disturb the porous medium. In an alternative embodiment, the outer surface of the water permeable member 352 is substantially aligned with the outer surface 322a of the access tube 320 in the expanded configuration.

In the embodiment shown, the insertion assembly 382 comprises two semicircular sections 382a, 382b pivotally connected to one another along a longitudinal edge thereof and an expansion member (not shown) located between the two semicircular sections 382a, 382b. In non-limitative embodiments, the expansion member can include a shaft and rocker assembly or an inflatable rubber bladder. The expansion member operates to move the two semicircular sections 382a, 382b towards one another when the insertion assembly 382 is configured in the compacted configuration and away from one another when the insertion assembly 382 is configured in the expanded configuration. In an embodiment, the expansion member can be configured to solely move the semicircular sections 382a, 382b away from one another. One skilled in the art will understand that, in alternative embodiments (not shown), the insertion assembly 382 can be embodied using different components which allow the contraction/expansion thereof.

In an embodiment (not shown), the water permeable member 352 can be part of a water supply and sensor assembly as described above (i.e. including a watertight tube, a water injection and withdrawal unit in liquid communication with the watertight tube and a pressure sensor operatively connected to the watertight tube) such that the insertion assembly 382 is used in an infiltrometer 240 as described above.

It is appreciated that wires and/or tubings can be mounted to the insertion assembly 382 to connect the water permeable member(s) 352 to sensors, water supplies, gas evacuation ports, data transmitter, and the like.

In an alternative embodiment, at least some of the fluid permeable members 353 can be gas permeable members. In other alternative embodiment, at least some of the fluid permeable members can be replaced by porous medium sensors in direct contact with the surrounding porous medium.

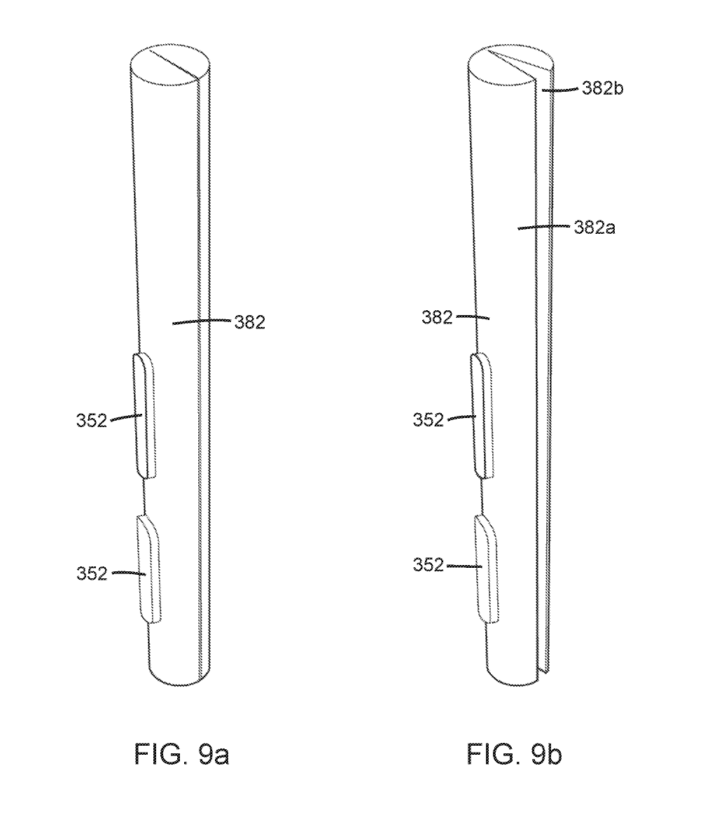

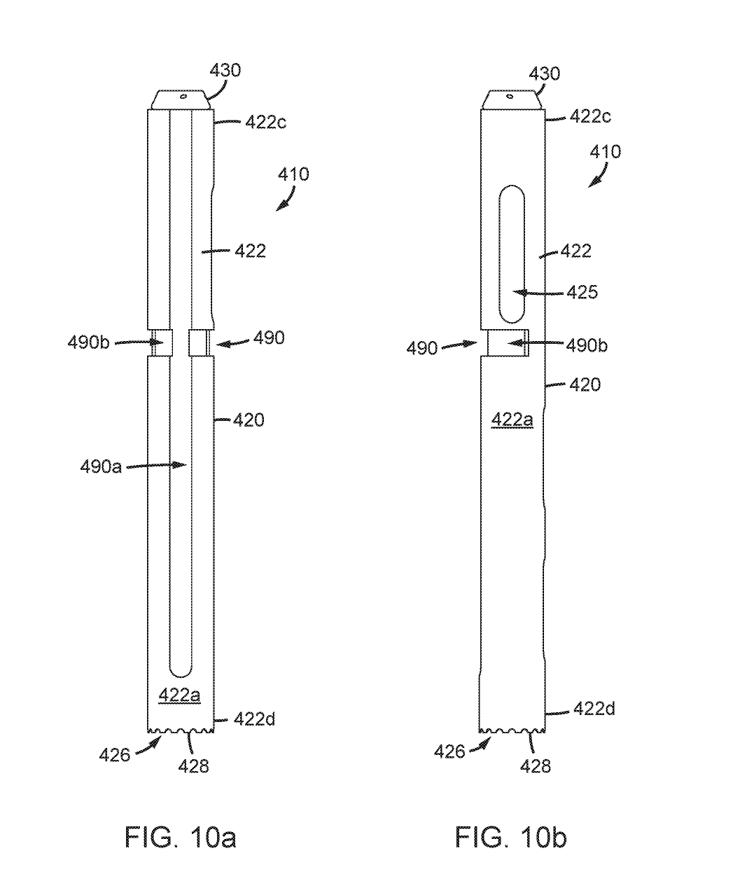

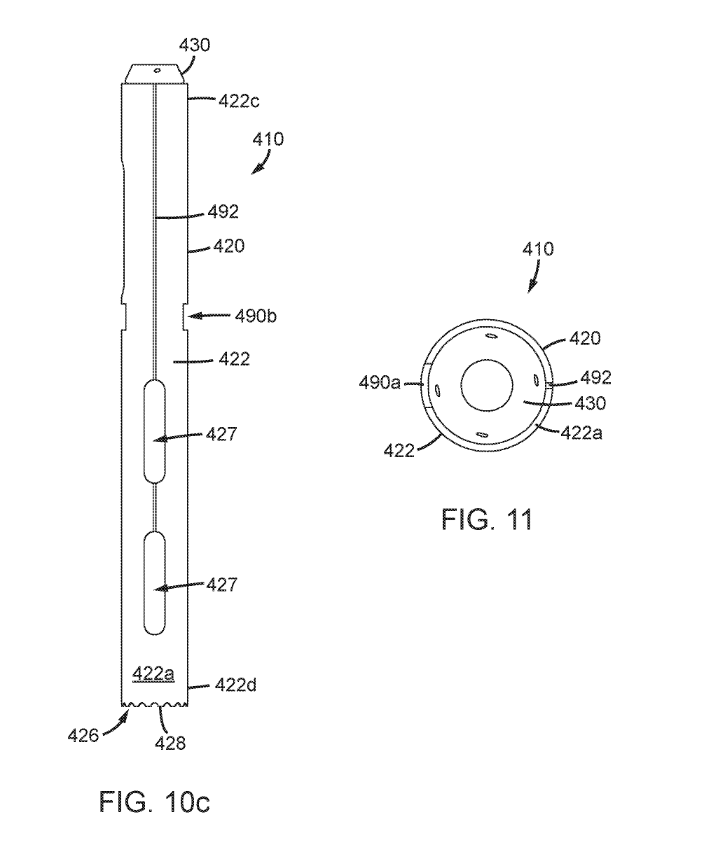

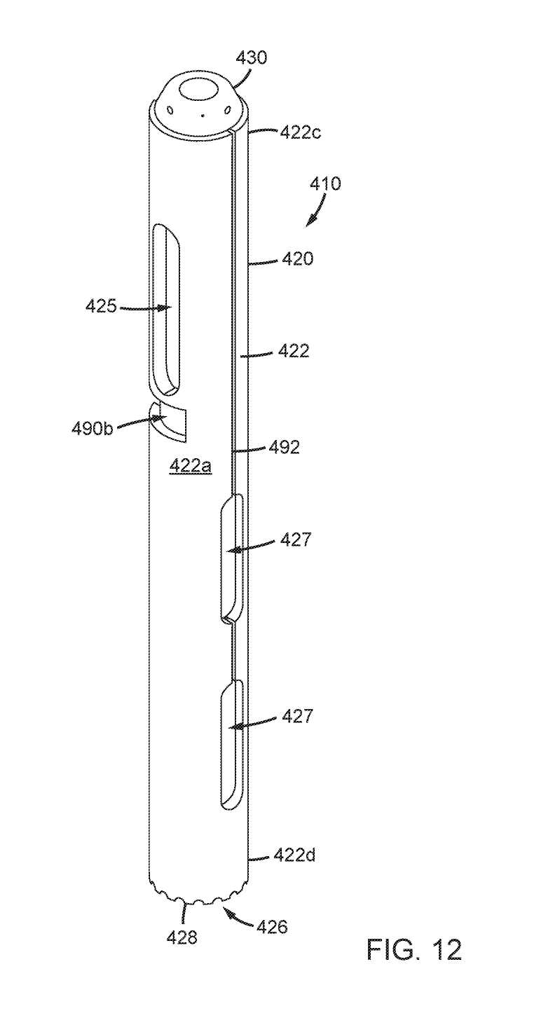

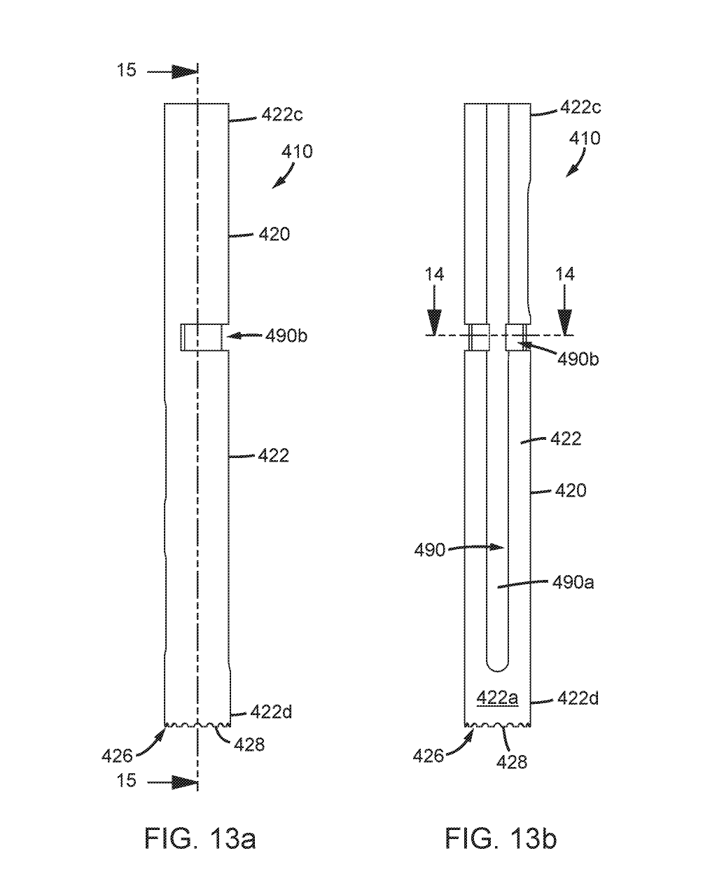

Now referring to FIGS. 10 to 15, there is provided an alternative embodiment of a porous medium extraction system 410 insertable in a porous medium (not shown). In FIGS. 10 to 15, features similar to the features of the porous medium extraction system 10 are numbered using the same reference numerals in the 400 series.

In the embodiment shown, the access tube 420 of the porous medium extraction system 410 includes a single section insertable in the porous medium.

In FIGS. 10 to 13, only the access tube 420 and the impact head 430 of the porous medium extraction system 410 are shown. However, it is appreciated that of the porous medium extraction system 410 can include a porous medium extracting screw (not shown) secured to the impact head 430 and insertable in the access tube 420 during insertion of the access tube 420 into the porous medium and extraction of the porous medium contained in the channel 424 of the access tube 420. For instance, the extracting screw can be substantially similar to the extracting screw shown in FIGS. 1 to 5 described above.

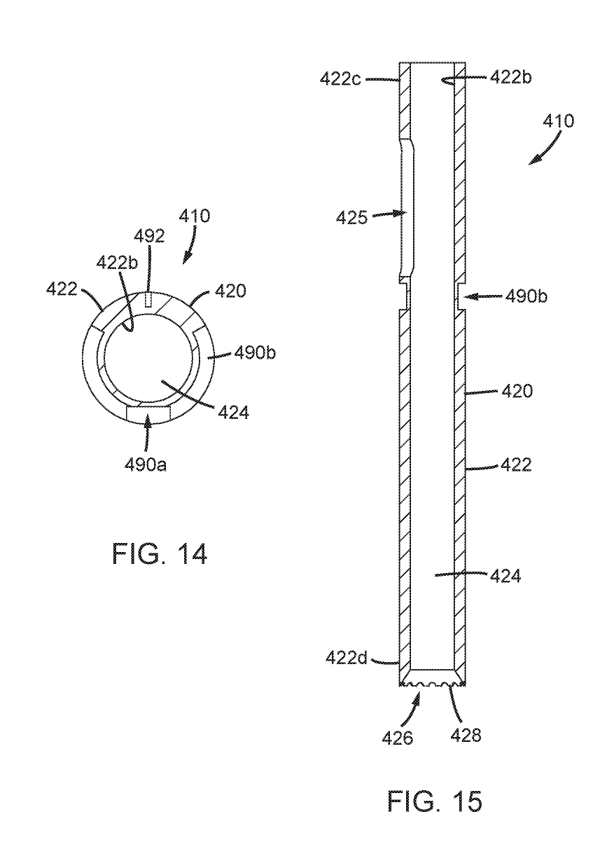

Except being single piece, the features of the access tube 420 are substantially similar to the features of the access tube 420. It includes an access tube wall 422 defining an open-ended channel 424. A lower end 422d of the access tube wall 22 comprises a cutting edge 426 bevelled towards an inner surface 422b of the access tube wall 422 (see FIG. 15) and including a plurality of teeth 428. The access tube 420 also includes a porous medium outlet 425 extending through the access tube wall 422, close to the upper end 422c. In the embodiment shown, the access tube 420 also includes two longitudinally spaced-apart sensing member cavities 427 defined in the access tube wall 422 and provided below the porous medium outlet 425, close to the lower end 422d, below the porous medium outlet 425. Unlike the porous medium access ports 27, the sensing member cavities 427 do not extend through the access tube wall 422 but define a recess in the access tube wall 422, from the outer surface 422a with the access tube wall 422 being thinner under the sensing member cavities 427.

Fluid permeable members (not shown), such as water and gas permeable members, or porous medium sensors can be mounted to the access tube wall 422 and, more particularly, at least partially contained inside the sensing member cavities 427. Each one of the sensing member cavities 427 can contain a respective fluid permeable member or a porous medium sensor. In an embodiment, the fluid permeable members or the porous medium sensor can project slightly outside of the access tube 420. One skilled in the art will understand that the fluid permeable members or the porous medium sensors can project sufficiently outside of the access tube 420 to provide good contact with the undisturbed porous medium. In an alternative embodiment, the outer surface of the fluid permeable members or porous medium sensors can be substantially aligned with the outer surface 422a of the access tube 420. The fluid permeable members or porous medium sensors can be mounted to the access tube 420, at least partially contained in the sensing member cavities 427, before inserting the access tube 420 in the porous medium. Thus, the fluid permeable member(s) or porous medium sensor(s) can be inserted simultaneously with the access tube 420 into the porous medium.

In the embodiment shown, the sensing member cavities 427 are radially aligned. However, it is appreciated that, in an alternative embodiment, the sensing member cavities 427 can be radially spaced-apart.

As for the embodiments described above in reference to FIGS. 1 to 5, it is appreciated that the shape and the configuration of the access tube 420, the porous medium outlet 425, and the sensing member cavities 427 can vary from the embodiment shown in FIGS. 10 to 15.

The impact head 430 is substantially similar to the impact head 30 shown in FIGS. 1 to 5 and described above and will not be described in further details.

The access tube wall 422 includes an expansion assembly channel 490 defined in an outer surface 422a thereof. In the embodiment shown, the expansion assembly channel 490 includes a longitudinal section 490a, extending longitudinally along a length of the access tube 420, and a transversal section 490b, extending transversally and intersecting with the longitudinal section 490a. In the embodiment shown, the longitudinal section 490a is located opposite the sensing member cavities 427, i.e. about 180° spaced-apart. In the embodiment shown, the transversal section 490b covers (or extends along) substantially half of the periphery of the access tube 420. It is located just above a mid-length of the access tube 420. The expansion assembly channel 490 does not extend through the access tube wall 422 but defines a recess in the access tube wall 422 with the access tube wall 422 being thinner along the expansion assembly channel 490. The purpose of the expansion assembly channel 490 will be described in further details below.

In the embodiment shown, the porous medium outlet 425 is located above the transversal section 490b of the expansion assembly channel 490 and the sensing member cavities 427 are defined below the transversal section 490b of the expansion assembly channel 490.

The access tube wall 422 also includes a connector channel 492 defined in an outer surface 422a thereof. In the embodiment shown, the connector channel 492 extends longitudinally along the access tube 420 and intersects with the sensing member cavities 427. It extends from the upper end 422c of the access tube 420 until meeting with an upper end of a lowest one of the sensing member cavities 427. The connector channel 492 is located opposite the longitudinal section 490a of the expansion assembly channel 490, i.e. they are diametrically opposed. As the expansion assembly channel 490, the connector channel 492 does not extend through the access tube wall 422 but defines a recess in the access tube wall 422 with the access tube wall 422 being thinner along the connector channel 492.

The porous medium extraction system 410 can also include an expansion member (not shown) mounted to the access tube and at least partially contained in the expansion assembly channel 490. The expansion member is configurable in an insertion configuration (compacted configuration) and an expanded configuration. For insertion of the access tube 420 into the porous medium, the expansion member is configured in the insertion configuration. Once inserted in the porous medium, to ensure a suitable contact between the fluid permeable members or porous medium sensors contained in the sensing member cavities and the adjacent porous medium, the expansion member is configured in the expanded configuration. In the expanded configuration, the expansion member applies pressure on the surrounding porous medium, thereby simultaneously translating the fluid permeable members or porous medium sensors, towards the porous medium to ensure full contact therewith. As mentioned above, the expansion assembly channel 490 containing the expansion member is located diametrically opposed to the sensing member cavities 427 containing the fluid permeable members or porous medium sensors.

Expansion members can include inflatable bladders or members which size can be increased to compress the opposed face of the access tube 420 against the porous medium to increase contact inbetween. In an embodiment, the size and shape of the expansion members substantially correspond to the size and shape of the expansion assembly channel 490. The expansion member contained in the transversal section 490b of the expansion assembly channel 490 ensures peripheral contact while the longitudinal section 490a of the expansion assembly channel 490 ensures a substantially uniform pressure along a longitudinal axis of the access tube 420.

The connector channel 492 is configured to contain wires and/or water tubings and/or other tubings to connect the fluid permeable members to sensors, water supplies, gas evacuation ports, data transmitter, and the like. In the embodiment wherein the sensing member cavities contain porous medium sensors, the connector channel 492 can include data transmitter, such electric wires, to transmit data to a control system.

The access tube 420 can be used as an infiltrometer, such as the access tube 220 described above in reference to FIG. 7. To be used as an infiltrometer, a water supply and sensor assembly (not shown), including amongst others, a fluid-tight tube (not shown), such as a watertight tube or a gastight tube, is coupled to the access tube 220. Since the access tube 420 does not include porous medium access port extending through the access tube wall 422, but includes sensing member cavities 427 with a section of the access tube wall 422 extending behind, the rear surface (not shown) of the fluid permeable member is not accessible from the channel of the access tube. Thus, as mentioned above, the fluid-tight tube and any other connectors connected to the fluid permeable member or porous medium sensor can extend through the connector channel 492 and be connected to the fluid-tight tube close to the front face thereof. For instance, for an infiltrometer, the fluid-tight tube extending longitudinally along the outer surface 422a of the access tube 420 can be in liquid communication the fluid permeable member. Thus, water and gas can flow from the porous medium to the fluid-tight tube, and vice-versa, through the fluid permeable member 252.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A porous medium infiltrometer insertable in a porous medium, the porous medium infiltrometer comprising:
an access tube at least partially insertable in the porous medium, the access tube having an access tube wall defining a channel therein and a sensing member cavity defined in an outer surface of the access tube wall, the sensing member cavity being located in the porous medium upon insertion of the porous medium infiltrometer therein; and
a water supply and sensor assembly engageable with the access tube and comprising:
a water permeable member insertable in the sensing member cavity of the access tube;
a watertight tube in liquid communication with the water permeable member;
a water injection and withdrawal unit in liquid communication with the watertight tube and operative to sequentially inject water in the watertight tube and withdraw water therefrom; and
a pressure sensor operatively connected to the watertight tube and operative to measure water pressure in the watertight tube.

2. The porous medium infiltrometer of claim 1, wherein the watertight tube comprises a gas collection section spaced-apart along the watertight tube from the pressure sensor and the water supply and sensor assembly further comprises a gas extraction assembly operatively connected to the watertight tube, the gas extraction assembly comprising:
a gas evacuation port in fluid communication with the gas collection section of the watertight tube, the gas evacuation port being configurable between an open configuration allowing gas evacuation from the gas collection section of the watertight tube and a closed configuration preventing gas evacuation from the gas collection section of the watertight tube; and
a sealing member positioned downstream of the gas collection section of the watertight tube and configurable in a sealed configuration sealing the watertight tube and an unsealed configuration allowing fluid transfer in the watertight tube, the sealing member being configured in the sealed configuration when the gas evacuation port is configured in the open configuration.

3. The porous medium infiltrometer of claim 2, wherein the watertight tube comprises a main section and a pressure sensor section, the gas collection section and the pressure sensor section branching from the main section and being located upstream thereof, the pressure sensor being located above the gas collection section when the access tube is at least partially inserted in the porous medium.

4. The porous medium infiltrometer of claim 1, wherein the sensing member cavity is a porous medium access port extending through the access tube wall and at least a section of the watertight tube of the water supply and sensor assembly is at least partially insertable in the channel of the access tube to be in liquid communication with the water permeable member from a rear surface thereof and wherein:
the water supply and sensor assembly further comprises an insertion assembly, the water permeable member being mounted to the insertion assembly, the insertion assembly being configurable in a compacted configuration for insertion and translation of the water permeable member in the channel of the access tube and an expanded configuration wherein the water permeable member is at least partially inserted in the porous medium access port; and
the water permeable member comprises a front surface contacting the porous medium when the porous medium infiltrometer is at least partially inserted therein and the insertion assembly is configured in the expanded configuration with the front surface projecting outside of the access tube, beyond the outer surface of the access tube wall.

5. The porous medium infiltrometer of claim 1, wherein the water permeable member is secured to the access tube with a section of the access tube wall extending rearwardly of the water permeable member and preventing liquid and gas communication between the channel of the access tube and the water permeable member through the sensing member cavity and wherein the access tube further comprises a connector channel defined in an outer surface of the access tube wall and extending longitudinally therealong from an upper end thereof and intersecting with the sensing member cavity and wherein the watertight tube is at least partially inserted in the connector channel and operatively connected to the water permeable member to be in liquid communication therewith.

6. The porous medium infiltrometer of claim 1, wherein the access tube comprises a plurality of longitudinally spaced-apart sensing member cavities defined in the access tube wall and a plurality of water supply and sensor assemblies and wherein the water permeable member of each one of the plurality of water supply and sensor assemblies being contained in a corresponding one of the plurality of sensing member cavities.

7. The porous medium infiltrometer of claim 1, wherein the access tube comprises a porous medium outlet defined through the access tube wall, above the sensing member cavity and a lower end of the access tube comprises a cutting edge bevelled towards an inner surface of the access tube wall.

8. A porous medium extraction system comprising:
an access tube having an access tube wall with an outer surface, an inner surface, an upper end, and an opposed lower end, and defining an open-ended channel extending along a longitudinal axis of the access tube, the lower end of the access tube comprising a cutting edge bevelled towards the inner surface of the access tube wall;
an impact head engageable with the upper end of the access tube; and
a porous medium extracting screw insertable in the open-ended channel of the access tube and being engageable with the porous medium located inside the open-ended channel upon insertion of the access tube in the porous medium, the porous medium extracting screw being rotatable to extract the porous medium from the open-ended channel.

9. The porous medium extraction system of claim 8, wherein the cutting edge comprises a plurality of teeth.

10. The porous medium extraction system of claim 8, wherein the impact head is mounted to the porous medium extracting screw and is movable about the longitudinal axis between a distal configuration and an engaged configuration and impacting on the upper end of the access tube wall when brought in the engaged configuration to drive the access tube into the porous medium.

11. The porous medium extraction system of claim 8, wherein the access tube comprises at least one porous medium outlet extending through the access tube wall in an upper section thereof, the at least one porous medium outlet being sized and shaped to allow the porous medium conveyed upwardly by the porous medium extracting screw to exit through the open-ended channel.

12. The porous medium extraction system of claim 11, wherein the access tube includes a lower access tube section detachably engageable with an upper access tube section, the lower access tube section being at least partially insertable in the porous medium and the upper access tube section extending at least partially outside of the porous medium upon insertion of the access tube therein and wherein the upper access tube section comprises at least one of the at least one porous medium outlet and the lower access tube section comprises at least one sensing member cavity defined in an outer surface of the access tube wall, the at least one sensing member cavity being located in the porous medium upon insertion of the access tube therein.

13. The porous medium extraction system of claim 8, wherein the access tube comprises an expansion assembly channel defined in an outer surface of the access tube wall and the porous medium extraction system further comprises an expansion member mounted to the access tube in the expansion assembly channel, the expansion member being selectively configurable in an insertion configuration wherein the expansion member is contained in the expansion assembly channel and an expanded configuration wherein the expansion member protrudes outwardly from the expansion assembly channel and wherein the access tube comprises at least one sensing member cavity defined in an outer surface of the access tube, in a lower section thereof.

14. The porous medium extraction system of claim 13, wherein the expansion assembly channel comprises a longitudinal section, the longitudinal section being diametrically opposed to the at least one sensing member cavity, and a transversal section intersecting with the longitudinal section and extending at least along half of a periphery of the access tube and wherein the access tube comprises at least one porous medium outlet extending through the access tube wall above the transversal section of the expansion assembly channel and the at least one sensing member cavity is defined below the transversal section of the expansion assembly channel.

15. A porous medium sensor assembly insertable in a porous medium, the porous medium sensor assembly comprising:
an access tube at least partially insertable in the porous medium, the access tube having an access tube wall defining a channel therein and a porous medium access port defined through the access tube wall, the porous medium access port being located in the porous medium upon insertion of the porous medium sensor assembly therein;
an insertion assembly configurable in a compacted configuration and an expanded configuration; and
at least one of a fluid permeable member and a porous medium sensor mounted to the insertion assembly, the at least one of the fluid permeable member and the porous medium sensor being longitudinally displaceable inside the access tube in the compacted configuration of the insertion assembly and being at least partially inserted in the porous medium access port of the access tube in the expanded configuration of the insertion assembly.

16. The porous medium sensor assembly of claim 15, further comprising an infiltrometer assembly including:
a water permeable member mounted to the insertion assembly and at least partially inserted in the porous medium access port of the access tube in the expanded configuration of the insertion assembly;
a watertight tube insertable in the channel of the access tube and being in liquid communication with the water permeable member;
a water injection and withdrawal unit in liquid communication with the watertight tube and operative to sequentially inject water in the watertight tube and withdraw water therefrom; and
a pressure sensor operatively connected to the watertight tube and operative to measure water pressure in the watertight tube.

17. The porous medium sensor assembly of claim 16, wherein the watertight tube comprises a gas collection section spaced-apart along the watertight tube from the pressure sensor and the infiltrometer assembly further comprises a gas extraction assembly operatively connected to the watertight tube, the gas extraction assembly comprising:
a gas evacuation port in fluid communication with the gas collection section of the watertight tube, the gas evacuation port being configurable between an open configuration allowing gas evacuation from the gas collection section of the watertight tube and a closed configuration preventing gas evacuation from the gas collection section of the watertight tube; and
a sealing member positioned downstream of the gas collection section of the watertight tube and configurable in a sealed configuration sealing the watertight tube and an unsealed configuration allowing fluid transfer in the watertight tube, the sealing member being configured in the sealed configuration when the gas evacuation port is configured in the open configuration.

18. The porous medium sensor assembly of claim 15, wherein the insertion assembly comprises two semicircular sections and an expansion member located therebetween, the expansion member being operative to move the two semicircular sections away from one another to configure the insertion assembly in the expanded configuration and the two semicircular sections are pivotally connected to one another along a longitudinal edge thereof.

19. The porous medium sensor assembly of claim 15, wherein the at least one of the fluid permeable member and the porous medium sensor comprises a front surface contacting the porous medium in the expanded configuration of the insertion assembly inserted in the channel of the access tube and wherein the access tube further comprises a porous medium outlet defined through the access tube wall and located above the porous medium access port.

20. A porous medium sensing assembly insertable in a porous medium, the porous sensing assembly comprising:
an access tube at least partially insertable in the porous medium, the access tube having an access tube wall with a sensing member cavity and an expansion assembly channel defined in an outer surface of the access tube wall, the sensing member cavity being in the porous medium upon insertion of the porous medium sensing assembly therein;
at least one of a fluid permeable member and a porous medium sensor mounted to the access tube and at least partially contained in the sensing member cavity and having a front surface contacting the porous medium upon insertion of the access tube therein; and
an expansion member mounted to the access tube in the expansion assembly channel, the expansion member being selectively configurable in an insertion configuration wherein the expansion member is contained in the expansion assembly channel and an expanded configuration wherein the expansion member protrudes outwardly from the expansion assembly channel.

21. The porous medium sensing assembly of claim 20, wherein the access tube wall defines a channel and the sensing member cavity is a porous medium access port extending through the access tube wall and communicating with the channel defined by the access wall and wherein the access tube further comprises a connector channel defined in an outer surface of the access tube wall and extending longitudinally therealong from an upper end thereof and intersecting with the sensing member cavity.

22. The porous medium sensing assembly of claim 20, wherein the expansion assembly channel comprises a longitudinal section and a transversal section, the longitudinal section being diametrically opposed to the at least one sensing member cavity and the transversal section intersecting with the longitudinal section and extending at least along half of a periphery of the access tube and wherein the access tube comprises at least one porous medium outlet extending through the access tube wall above the transversal section of the expansion assembly channel and the at least one sensing member cavity is defined below the transversal section of the expansion assembly channel.
